(19) United States
(12) Patent Application Publication
(10) Pub. No.: US 2011/0050571 A1
(43) Pub. Date: Mar. 3, 2011

(54) REMOTE CONTROL SYSTEM AND METHOD FOR COMPUTER

(75) Inventor: Kuan-Lin Wu, Tu-Cheng (TW)

(73) Assignee: HON HAI PRECISION INDUSTRY CO., LTD., Tu-Cheng (TW)

(21) Appl. No.: 12/562,074

(22) Filed: Sep. 17, 2009

(30) Foreign Application Priority Data
Aug. 27, 2009 (CN) 200910306186.2

(51) Int. Cl. G09G 5/08

(52) U.S. Cl. 345/163

(57) ABSTRACT

A remote control system for a computer includes a transmitting apparatus generating move instructions and key-press instructions. A receiving apparatus is connected to the computer, to receive the move instructions and key-press instructions and send the move instructions and key-press instructions to the computer. The receiving apparatus includes an infrared-house module transmitting an infrared to the transmitting apparatus and an infrared camera module capturing a location and a move state of the transmitting apparatus according to a reflected infrared from the transmitting apparatus and converting the captured location and move state to images and sending the images to the computer. The computer converts the key-press instructions to key-press data and converts the key-press data into key-press actions of a cursor of the computer, and converts the images to movement data and converts the move data into movement actions of the cursor of the computer.

### BACKGROUND

1. Technical Field

The present disclosure relates to remote control systems and remote control methods, and particularly, to a remote control system and a remote control method for a computer.

2. Description of Related Art

Conventionally, a computer is operated by a mouse of the computer, for example, a menu of the computer is selected, opened, or closed by using the mouse. Therefore, a user must be physically close to the mouse of the computer to operate the computer. However, this way limits the movement range of the user of the computer, which is inconvenient for the user.

### BRIEF DESCRIPTION OF THE DRAWINGS

FIG. 1 is a schematic diagram of an embodiment of a remote control system for a computer, the remote control system includes a wireless transmitting apparatus and a wireless receiving apparatus.

FIG. 2 is a block diagram of an embodiment of the wireless transmitting apparatus of FIG. 1.

FIG. 3 is a block diagram of an embodiment of the wireless receiving apparatus of FIG. 1.

FIGS. 4A and 4B are a flowchart of an embodiment of a remote control method for a computer.

### DETAILED DESCRIPTION

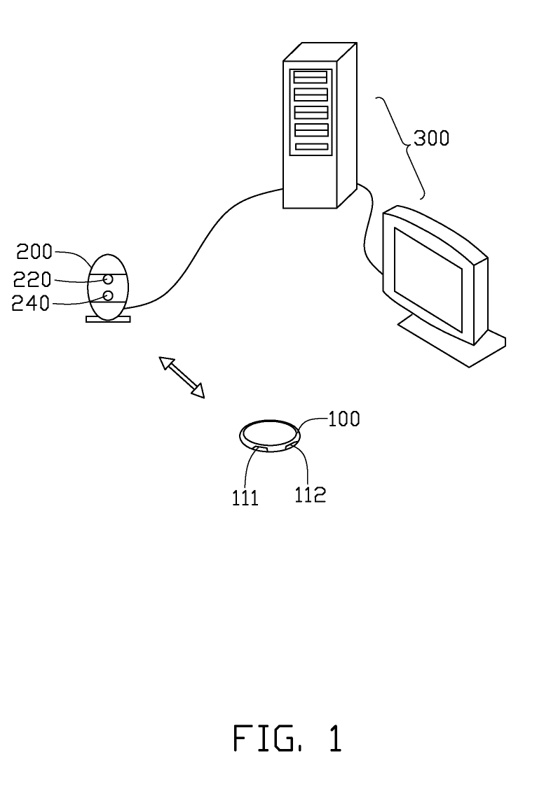

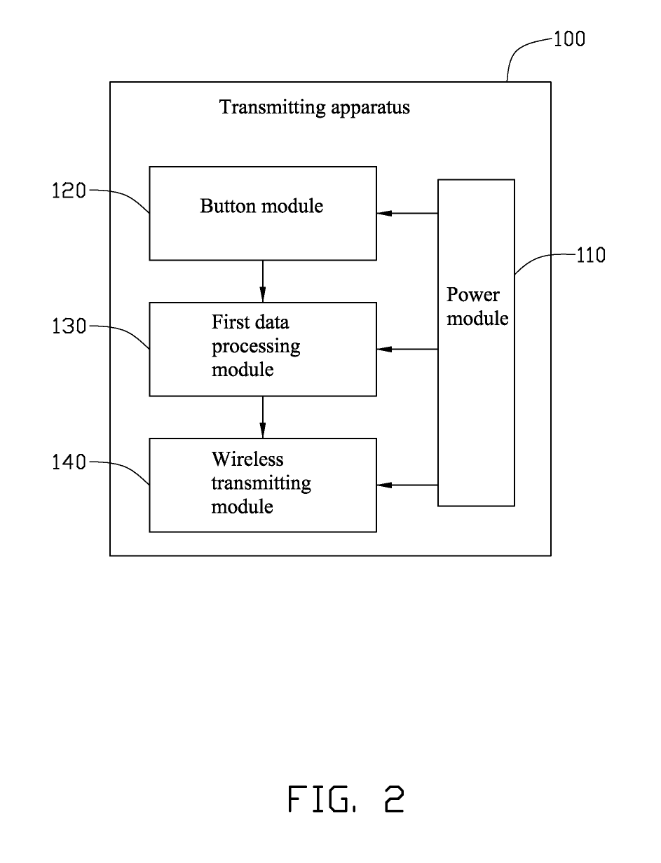

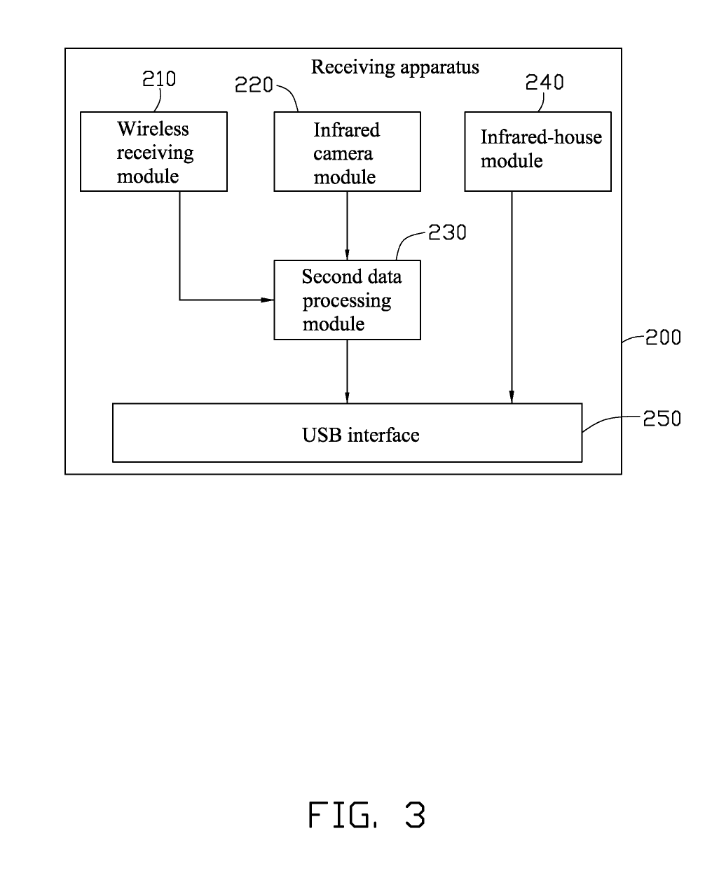

Referring to FIGS. 1-3, an exemplary embodiment of a remote control system includes a transmitting apparatus 100, a receiving apparatus 200, and a computer 300.

The transmitting apparatus 100 generates move instructions and key-press instructions. The receiving apparatus 200 receives the move instructions and key-press instructions and sends the move instructions and key-press instructions to the computer 300. The computer 300 receives the move instructions and key-press instructions from the receiving apparatus 200 and converts the move instructions and key-press instructions into actions of a cursor of the computer 300 and performs corresponding functions. In one embodiment, the transmitting apparatus 100 may be ring-shaped, and can be worn on a finger of a user of the computer 300. Two buttons 111 and 112 are set on the transmitting apparatus 100, to generate the key-press instructions. Material of a surface of the transmitting apparatus 100 has a high infrared reflectivity character. The receiving apparatus 200 is connected to the computer 300, and can be optionally located around the transmitting apparatus 100, to receive the move instructions and key-press instructions from the transmitting apparatus 100.

The transmitting apparatus 100 includes a power module 110, a button module 120, a first data processing module 130, and a wireless transmitting module 140. The power module 110 provides voltages to the button module 120, the first data processing module 130, and the wireless transmitting module 140. The button module 120 outputs the key-press instructions via operating the buttons 111 and 112. The first data processing module 130 receives the key-press instructions from the button module 120 and sends the key-press instructions to the receiving apparatus 200 via the wireless transmitting module 140. The wireless transmitting module 140 sends the key-press instructions to the receiving apparatus 200, then to the computer 300, to control a cursor of the computer 300 to open or close menus of the computer 300.

The receiving apparatus 200 includes a wireless receiving module 210, an infrared camera module 220, a second data processing module 230, an infrared-house module 240, and a universal serial bus (USB) interface module 250. The receiving apparatus 200 is connected to the computer 300 via the USB interface 250. The wireless receiving module 210 receives the key-press instructions from the transmitting apparatus 100 and sends the key-press instructions to the second data processing module 230, to send the key-press instructions to the computer 300 via the USB interface 250. The computer 300 receives the key-press instructions and converts the key-press instructions into key-press data, and then converts the key-press data into key-press actions of the cursor of the computer 300. The infrared-house module 240 sends infrared to the transmitting apparatus 100. The infrared camera module 220 receives feedback infrared from the transmitting apparatus 100 and captures a location and a movement state of the transmitting apparatus 100 according to the feedback infrared, and converts the location and the movement state into images and then sends the images to the second data processing module 230. The second data processing module 230 receives the images and sends the images to the computer 300 via the USB interface 250. The computer 300 receives the images and converts the images into movement data, and then converts the movement data into movement actions of the cursor of the computer 300.

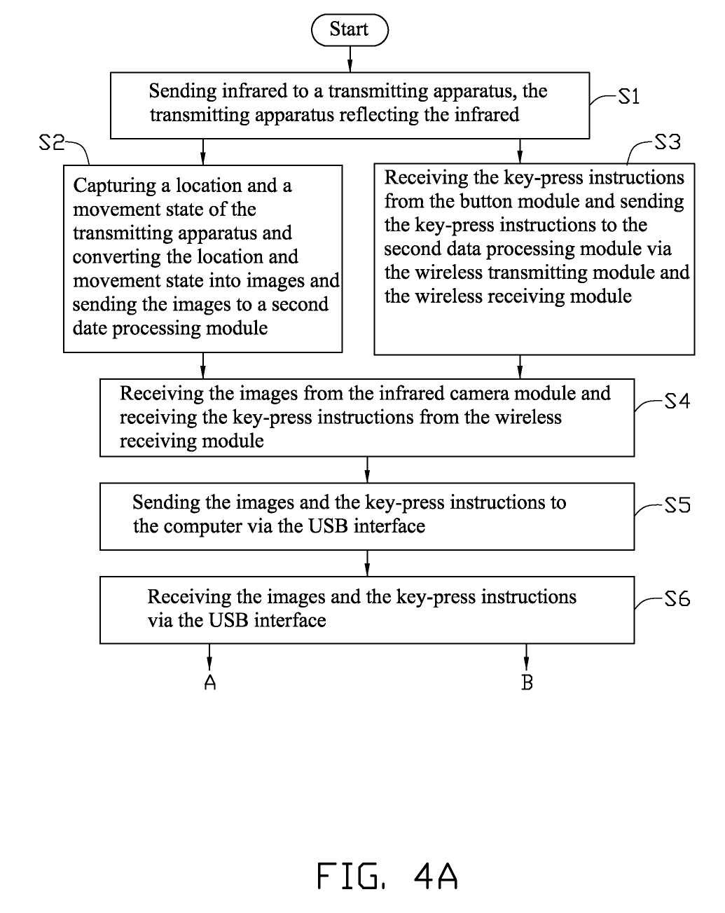

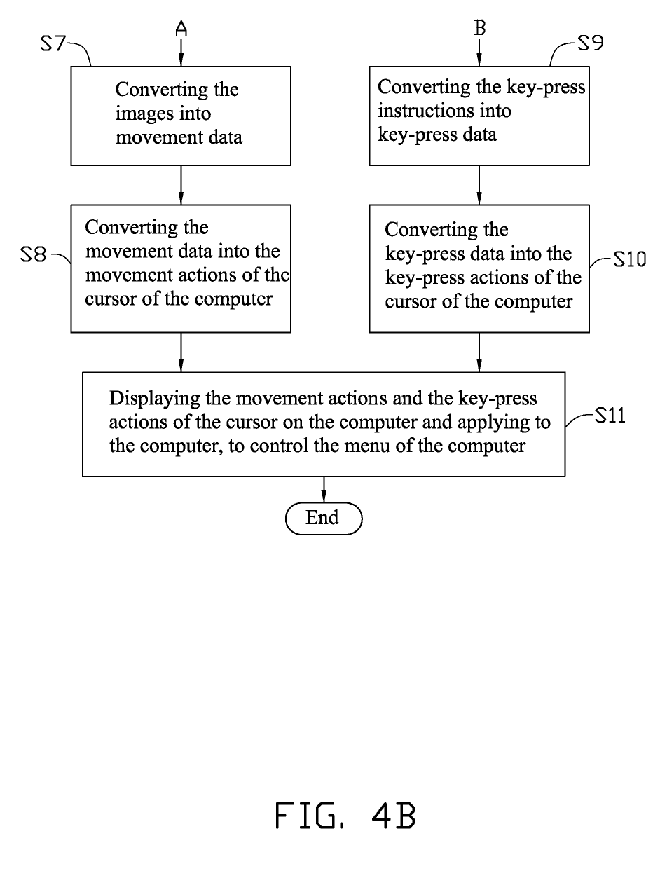

Referring to FIGS. 4A and 4B, an exemplary embodiment of a remote control method for a computer includes the following steps.

In step S1, the infrared-house module 240 sends infrared to the transmitting apparatus 100, the transmitting apparatus 100 reflects the infrared, when the infrared camera module 220 receives the reflected infrared by the transmitting apparatus 100, the procedure goes to step S2, when the buttons 111 or 112 of the button module 120 are clicked, the procedure goes to step S3.

In step S2, the infrared camera module 220 captures the location and the movement state of the transmitting apparatus 100 according to the reflected infrared, and converts the location and movement state into images and then sends the images to the second date processing module 230.

In step S3, the first data processing module 130 receives the key-press instructions from the button module 120 and sends the key-press instructions to the second data processing module 230 via the wireless transmitting module 140 and the wireless receiving module 210.

In step S4, the second data processing module 230 receives the images from the infrared camera module 220 and receives the key-press instructions from the wireless receiving module 210.

In step S5, the second data processing module 230 sends the images and the key-press instructions to the computer 300 via the USB interface 250.

In step S6, the computer 300 receives the images and the key-press instructions via the USB interface 250, if the computer 300 receives the images, the procedure goes to step S7, if the computer 300 receives the key-press instructions, the procedure goes to step S9.

In step S7, the computer 300 converts the images into movement data.

In step S8, the computer 300 converts the movement data into movement actions of the cursor of the computer 300.

In step S9, the computer 300 converts the key-press instructions into key-press data.

In step S10, the computer 300 converts the key-press data into key-press actions of the cursor of the computer 300.

In step S11, the movement actions and the key-press actions of the cursor are displayed on the computer 300 and applied to the computer 300, to control the menu of the computer 300.

The remote control system and method for computer generates corresponding operation actions in the computer 300 according to the free movement state of the transmitting apparatus 100. Therefore, the user of the computer 300 can remote control the computer 300 conveniently.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching. The embodiments were chosen and described in order to explain the principles of the disclosure and their practical application so as to enable others skilled in the art to utilize the disclosure and various embodiments and with various modifications as are suited to the particular use contemplated. Alternately embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A remote control system for a computer, comprising:
a transmitting apparatus to generate move instructions and key-press instructions; and
a receiving apparatus connected to the computer, to receive the move instructions and key-press instructions and send the movement instructions and key-press instructions to the computer, the receiving apparatus comprising:
an infrared-house module to transmit infrared to the transmitting apparatus; and
an infrared camera module to capture a location and a move state of the transmitting apparatus according to reflected infrared by the transmitting apparatus and convert the captured location and move state of the transmitting apparatus into images, and send the images to the computer;
wherein the computer converts the key-press instructions to key-press data and converts the key-press data into key-press actions of a cursor of the computer; the computer converts the images into movement data and converts the movement data into movement actions of the cursor of the computer.

2. The remote control system of claim 1, wherein the transmitting apparatus comprises two buttons to generate the key-press instructions, the material of a surface of the transmitting apparatus has a high infrared reflectivity character.

3. The remote control system of claim 2, wherein the transmitting apparatus is ring-shaped.

4. The remote control system of claim 1, wherein the transmitting apparatus comprises:
a button module to output the key-press instructions, to control the cursor of the computer to open or close a menu of the computer;
a wireless transmitting module;
a first data processing module to receive the key-press instructions from the button module and send the key-press instructions to the receiving apparatus via the wireless transmitting module; and
a power module to provide voltages to the button module, the first data processing module, and the wireless transmitting module.

5. The remote control system of claim 1, wherein the receiving apparatus further comprises:
a universal serial bus (USB) interface to connect the receiving apparatus to the computer;
a wireless receiving module to receive the key-press instructions from the transmitting apparatus and output the key-press instructions to the computer; and
a second data processing module to receive the images from the infrared camera module and send the images to the computer via the USB interface, and receive the key-press instructions from the wireless receiving module and send the key-press instructions to the computer via the USB interface.

6. A remote control method for a computer, comprising:
a: an infrared-house module sending infrared to a transmitting apparatus, the transmitting apparatus reflecting the infrared, when an infrared camera module receiving a reflected infrared from the transmitting apparatus, the procedure goes to step b, when buttons of a button module of the transmitting apparatus is operated, the procedure goes to step c;
b: capturing a location and a movement state of the transmitting apparatus according to the reflected infrared, and converting the location and the movement state of the transmitting apparatus into images and sending the images to a second date processing module;
c: receiving the key-press instructions from the button module and sending the key-press instructions to the second data processing module via a wireless transmitting module and a wireless receiving module;
d: receiving the images from the infrared camera module and receiving the key-press instructions from the wireless receiving module;
e: sending the images and the key-press instructions to the computer via a universal serial bus (USB) interface;
f: receiving the images and the key-press instructions via the USB interface, if receiving the images, the procedure goes to step g, if receiving the key-press instructions, the procedure goes to step h;
g: converting the images into movement data;
h: converting the movement data into the movement actions of the cursor of the computer;
i: converting the key-press instructions to key-press data;
j: converting the key-press data into key-press actions of the cursor of the computer; and
k: displaying the movement actions and the key-press actions of the cursor on the computer and applying to the computer, to control a menu of the computer.
